(19) United States
(12) Patent Application Publication
(10) Pub. No.: US 2011/0047010 A1
(43) Pub. Date: Feb. 24, 2011

(54) ARTICLE VENDING MACHINE AND METHOD FOR RECEIVING RESTRICTED DISCOUNT CODES

(75) Inventors: Elizabeth Catherine Arnold, Chicago, IL (US); Jeanne Steinbach, Chicago, IL (US)

Correspondence Address: PATENT ADMINISTRATOR;NEAL, GERBER, & EISENBERG, SUITE 1700, 2 NORTH LASALLE STREET, CHICAGO, IL, 60602, US

(73) Assignee: Redbox Automated Retail, LLC, Oakbrook Terrace, IL (US)

(21) Appl. No.: 12/545,552

(22) Filed: Aug. 21, 2009

(51) Int. Cl. G06Q 30/00

(52) U.S. Cl. 705/14.1

(57) ABSTRACT

A network of DVD dispensing machines and method for accepting user-inputted coupon codes that are only accepted when certain restrictions are satisfied. In one aspect of the present invention, certain coupon codes are only accepted by kiosks located in certain geographic areas. In another aspect of the present invention, certain coupon codes are only accepted if the customer is a new customer opening a new account. In another aspect of the present invention, certain coupon codes are only accepted once per user account. In yet another aspect of the present invention, certain coupon codes are only accepted if the coupon codes are used at kiosks housed in certain vending partners or in stores affiliated with a certain entity.

### TECHNICAL FIELD

The present invention relates to improvements in article dispensing systems and components and methods related to the same. More particularly, the present invention relates to a digital content media, such as a digital video disc (DVD), dispensing apparatus and network.

### BACKGROUND AND SUMMARY OF THE INVENTION

While the present invention is often described herein with reference to a digital video disc distribution system, an application to which the present invention is advantageously suited, it will be readily apparent that the present invention is not limited to that application and can be employed in article dispensing systems used to distribute a wide variety of dispensable articles.

The digital video disc (DVD) player has been the most successful consumer electronics product launch in history. The market for DVD movie video and video game rentals is enormous and growing. Millions of households have acquired DVDs since they were introduced in 1997. In the first quarter of 2003 alone, it was estimated that well over three million DVD players were shipped to U.S. retailers.

In 2003, brick-and-mortar stores dominated the movie video and video game rental landscape in the U.S. Statistics showed that two brick-and-mortar companies controlled nearly sixty-five percent of the home video rental business. One element repeatedly cited for success of certain brick-and mortar store video rental franchises was perceived high availability of new video releases. Consumers want entertainment on demand, and through stocking multiple units of each new release, successful brick-and-mortar companies meet this consumer demand.

Pay-per-view video services and Internet-based video rental services are also known. Internet based video rental services have been plagued by their inability to meet the demands of consumers for new video releases during peak viewing times, leading to increased customer dissatisfaction. Pay-per-view video services offer only limited selections to viewers during any time period, and cannot be used with portable DVD players, resulting in significantly less rentals per any given period of time.

The foregoing indicates that there is a significant market potential for aligning regular routines of consumers (e.g., shopping, getting coffee or gas or going to a convenience store) with their DVD movie video and video game rental activities.

One improved DVD dispensing machine is disclosed in commonly owned U.S. Pat. No. 7,234,609, which is herein incorporated by reference in its entirety. The invention of the U.S. Pat. No. 7,234,609 and the present invention can function as a DVD dispensing machine-based distribution system that will typically have multiple units of each new release per DVD dispensing machine. The dispensing machines of the U.S. Pat. No. 7,234,609 and the present invention can stock up to two thousand DVDs (movies, games or other entertainment content), making the system competitive with existing brick-and-mortar video rental superstores.

The dispensing machine and system of the U.S. Pat. No. 7,234,609 and the present invention distinguishes itself from such stores by offering major benefits not conventionally offered by such stores, including additional cross-marketing programs (e.g., promotional rentals for a certain amount of dollars spent at the hosting store) and convenience (e.g., open always).

The dispensing machine of the U.S. Pat. No. 7,234,609 and the present invention yields a competitive advantage in the DVD rental marketplace by offering consumers cross-marketing/promotional programs, convenience of selection (e.g., computer-based searches for movies and recommendations based on consumer profiles), and potentially extended hours. The present invention employs a more cost-effective, convenient platform than brick-and-mortar stores. In addition, with the present invention, DVD dispensing machines can be situated in hosting locations having high foot traffic, such as at a popular grocery store, restaurant, drug store, and/or other popular hosting location.

The dispensing machine of the U.S. Pat. No. 7,234,609 and the present invention can be operated at a substantial savings over the costs associated with traditional brick-and-mortar video rental stores. For example, the present invention does not require hourly employees manning the dispensing machines or restocking them with inventories, due to the ability of the article transport storage units to be delivered to/picked up from host locations by third-party delivery services, such as traditional or contracted courier services.

Unlike brick-and-mortar stores, the dispensing machine of the U.S. Pat. No. 7,234,609 and the present invention does not require an on-site store manager because all operational decisions can be made at a centralized location by a management team officed remote from the hosting locations. Unlike brick-and-mortar stores, the dispensing machine of the U.S. Pat. No. 7,234,609 and the present invention does not require significant physical space. Unlike brick-and-mortar stores, the dispensing machine of the U.S. Pat. No. 7,234,609 and the present invention has low operating costs because no heating or air conditioning is required for the dispensing machines and they consume a relatively low level of electrical energy. In addition, the dispensing machine of the U.S. Pat. No. 7,234,609 has low maintenance costs and downtime.

The dispensing machine of the U.S. Pat. No. 7,234,609 and the present invention addresses the shortcomings of traditional brick-and-mortar stores in a convenient and cost-effective delivery vehicle having the added bonus of serving as an effective promotional platform that drives incremental sales to hosting locations. In addition, the dispensing machine of the U.S. Pat. No. 7,234,609 and the present invention overcomes these disadvantages by at least offering more new releases and older selections for any given time period, and lower cost per viewing with significantly more convenience than Internet-based and pay-per-view services.

The dispensing machine of the U.S. Pat. No. 7,234,609 and the present invention is a fully automated, integrated DVD movie video and video game rental and/or purchase systems. It preferably incorporates robust, secure, scalable software that provides a fully personalized user experience and real-time feedback to hosting locations and advertisers, scalable hardware that leverages existing technologies such as touch screen, focused audio speakers and plasma video monitors, technology utilizing the Internet through a system website, and an article transport storage unit that facilitates the exchange of new DVDs for old DVDs in each machine with virtually no need for human intervention. These technologies and others fill long-felt needs in the art and give advantages over conventional video distribution options. The dispensing machine of the U.S. Pat. No. 7,234,609 and the present invention functions as much as a promotional platform as it does a rental kiosk.

By utilizing the dispensing machines and the fully-interactive, real-time, linked Internet website, consumers can rent one or more DVD movie videos, video games, or other entertainment content directly from dispensing machines as well as indirectly by making a rental reservation through the website for later pickup at a conveniently located machine. These dispensing machines are preferably networked with each other, with the inventory control and/or supply office and with the system website by phone-line, DSL, or other Internet connection at each hosting location. Through this linked network, the rental experience for each consumer can be customized based on a profile for each consumer, such as via personalized home pages and rental screens.

Yet another benefit of the present invention is that it can accept and validate easily-distributed and redeemed coupon codes, which may be restricted to specific types of customers, markets, vendors and numbers of uses. The coupon codes can be tailored to provide an incentive-based promotion targeted to a specific types of customer, market, vendor and numbers of uses, thereby allowing the coupon provider to maximize the effectiveness of the promotion without incurring the expense of excess discounts to non-targeted consumers. The coupon codes can also be easily added, edited and managed by an administrator or management team at a centralized location.

Providing discounts to incentivize customer transactions is a common marketing method. In traditional retail sales, often such discounts are represented by paper coupons which entitle the bearer of the paper coupon to a discount. One advantage of paper coupons is that a paper coupon may be limited to specific users or a specific market or geography to target those individuals for a certain promotion. For example, if a coupon provider is introducing a new product in a certain city and wishes to promote sales of the new product in only that city, coupons may be distributed only to customers in that city. Or, assuming that a list of customers has been maintained, coupons may be mailed only to new customers. Thus, the coupon provider can control who uses the coupons, for the most part, by controlling who receives the paper coupons.

Typical Internet-based retailers that provide mail order shipments of goods purchased over the Internet, on the other hand, offer multi-digit alpha-numeric codes called “coupon codes” instead of paper coupons. When a user enters a coupon code into a purchasing screen during an on-line transaction, the coupon code entitles the user to a discount. Coupon codes have the advantage that they can be distributed quickly and inexpensively, for example, via email. Another advantage of coupon codes is that they can be entered by a user with a simple keyboard without the need for a bar-code scanning device or an attendant to read the coupon. Coupon codes also have the advantage that there is no need for the seller to receive and store a physical coupon for accounting purposes. However, one disadvantage of coupon codes is that they can be posted online or otherwise transmitted for use by anyone who views the code. Unlike traditional paper coupons, they are not limited by the number of physical coupons distributed or limited by the need for a consumer to physically possess a coupon. This limitation is generally not a problem for typical Internet-based retailers because they have little or no need to conduct targeted promotions. Such targeted promotions are unnecessary for typical Internet retailers because a new product sold through a website is typically available to all consumers independent of their geographic location. Thus, there is little incentive for typical Internet retailers to limit a promotion geographically or otherwise.

The present invention is directed to a network of DVD dispensing machines and method for accepting user-inputted coupon codes that are only accepted when certain restrictions are satisfied. By using coupon codes to entitle consumers to discounts, the present invention allows for coupon codes to be distributed cheaply and quickly and allows the coupon codes to be entered at a dispensing machine without any scanning equipment and without the receipt of a physical coupon. The present invention also overcomes many of the disadvantages of coupon codes. In one aspect of the present invention, certain coupon codes are only accepted by kiosks located in certain geographic areas. In another aspect of the present invention, certain coupon codes are only accepted if the customer is a new customer opening a new account. In another aspect of the present invention, certain coupon codes are only accepted once per user account. In yet another aspect of the present invention, certain coupon codes are only accepted if the coupon codes are used at kiosks housed in certain vending partners or in stores affiliated with a certain entity. For example, certain coupon codes may only be redeemed at a dispensing machine located in a Walgreens store. Thus, by coupling restrictions to the redemption of the coupon codes, the present invention allows for targeted and limited coupon codes. Other features and advantages are provided by the following description and drawings.

### BRIEF DESCRIPTION OF THE DRAWINGS

FIG. 1 is an illustration of a system for communicating and processing information in a network of article dispensing machines and dispensing apparatus;

FIG. 2 is a perspective view of an article dispensing machine constructed in accordance with the principles of the present invention;

FIG. 3 is a partially open perspective view of the article dispensing machine of FIG. 2;

FIG. 4 is a partially open side elevational view of the view of the article dispensing machine of FIG. 2 with certain components removed for clarity;

FIG. 5 is a flowchart illustrating an order of operations performed by an article dispensing machine connected to a network for receiving and validating a coupon code;

FIG. 6 is a flowchart illustrating an order of operations performed by an article dispensing machine for performing an offline provisional code acceptance;

FIG. 7 is a flowchart illustrating an order of operations performed by an article dispensing machine for performing an offline code attribute check;

FIG. 8 is a flowchart illustrating an order of operations performed by an article dispensing machine for receiving and validating a coupon code at the article dispensing machine;

FIG. 9 is a flowchart illustrating an order of operations performed by a network of article dispensing machines for transferring coupon codes from a central database to an article dispensing machine;

FIG. 10 is one embodiment of a coupon code configuration user interface screen;

FIG. 11 is one embodiment of a coupon code usage user interface screen;

FIG. 12 one embodiment of an article dispensing machine parameter user-interface screen.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

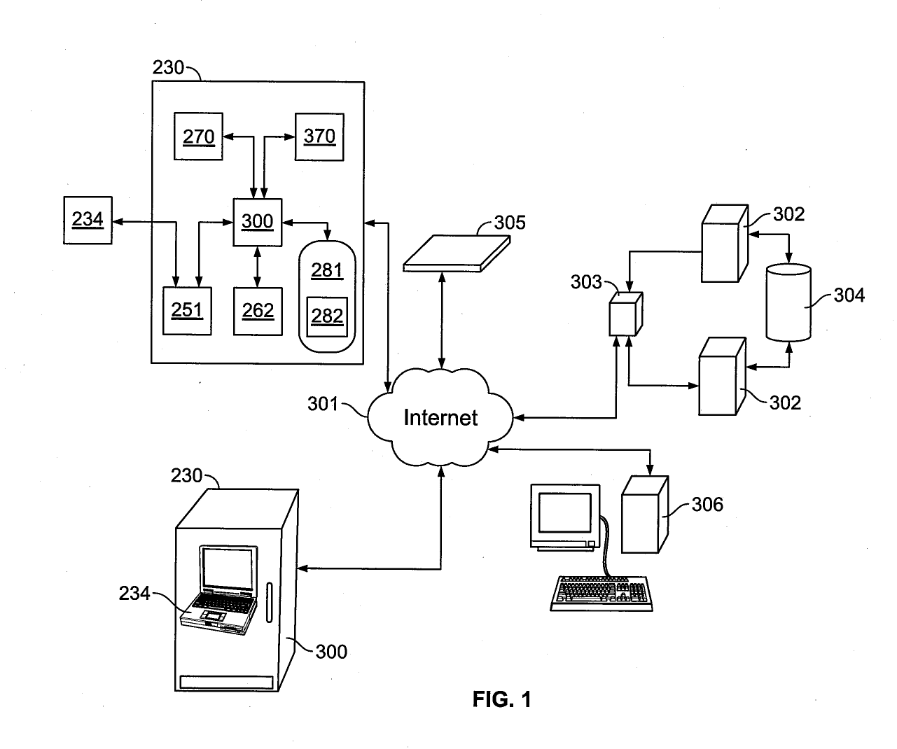

FIGS. 1-4 illustrate an article dispensing machine designated 230. Article dispensing machine 230 is one of a plurality of article dispensing machines included within an article distribution system having a plurality of such machines situated at a plurality of hosting locations. The article dispensing machines of a particular article distribution system preferably form a network. As such, those machines are preferably in electrical communication with each other and with a central server or central controller.

As shown in FIG. 1, each article dispensing machine 230 includes a dispensing machine processor 300, also referred to herein as a vending controller, which is connected to a first sensor 270 and second a second sensor 370, a first motor 251 and a second motor 262 and a user interface control system 234, collectively referred to as “the peripheral devices.” The processor is capable of executing various programs to provide input to and/or receive outputs from the peripheral devices. Suitable processors for such use are known to those of skill in the art. In addition, the processor is operably connected to at least one memory storage device 281, such as a hard-drive or flash-drive or other suitable memory storage device.

Article dispensing machine memory storage device 281 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, article dispensing machine memory storage device 281 may incorporate electronic, magnetic, optical, and/or other types of storage media. Article dispensing machine memory storage device 281 can have a distributed architecture where various components are situated remote from one another, but are still accessed by processor. Article dispensing machine memory storage device includes an article dispensing machine database 282.

The article dispensing machines 230 preferably comprise a network of machines in communication with one another. As shown in FIG. 1, in the preferred configuration, the article dispensing machines 230 are networked with one another via a central server or central controller 302 in a hub-and-spoke system. However, optionally, the article dispensing machines may be connected and communicate directly with one another, and/or subsets of article dispensing machines may communicate with one another directly as well as with the central server 302.

Generally, in terms of hardware architecture, the central server 302 includes a central processor and/or controller, central memory, and one or more input and/or output (I/O) devices (or peripherals) that are communicatively coupled via a local interface. The architecture of the central server is set forth in greater detail in U.S. Pat. No. 7,234,609, the contents of which are incorporated herein by reference. Numerous variations of the architecture of the central server would be understood by one of skill in the art and are encompassed within the scope of the present invention.

Steps and/or elements, and/or portions thereof of the present invention may be implemented using a source program, executable program (object code), script, or any other entity comprising a set of instructions to be performed. When a source program, the program needs to be translated via a compiler, assembler, interpreter, or the like, which may or may not be included within the memory, so as to operate properly in connection with the operating system (O/S). Furthermore, the software embodying the present invention can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. frequency (RF) or other transceiver, a telephonic interface, a bridge, and a router.

When article dispensing machine 230 is in operation, the article dispensing machine processor is configured to execute software stored within article dispensing machine memory, to communicate data to and from the dispensing machine memory, and to generally control operations of article dispensing machine pursuant to the software. The software aspects of the present invention and the O/S, in whole or in part, but typically the latter, are read by processor, perhaps buffered within the processor, and then executed.

When the present invention or aspects thereof are implemented in software, it should be noted that the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The present invention can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

For communication with the central server 302, article dispensing machine 230 is equipped with network communication equipment and circuitry. In a preferred embodiment, the network communication equipment includes a network card such as an Ethernet card. In a preferred network environment, each of the plurality of article dispensing machines 230 on the network is configured to use the TCP/IP protocol to communicate via the network 301. It will be understood, however, that a variety of network protocols could also be employed, such as IPX/SPX, Netware, PPP and others. It will also be understood that while a preferred embodiment of the present invention is for article dispensing machine 230 to have a “broadband” connection to the network 301, the principles of the present invention are also practicable with a dialup connection using a standard modem. Wireless network connections are also contemplated, such as wireless Ethernet, satellite, infrared and radio frequency networks.

The central controller 302 communicates with the article dispensing machine controllers 300 via the network 301. The central controller 302 is preferably located at a central station or office that is remote from the plurality of article dispensing machines 230. The central controller 302 can operate as the server for communicating over the network 301 between the plurality of article dispensing machines 230. The central controller 302 receives communications and information from the article dispensing machines 230, and also transmits communications and information to the machines 230. For example, when a DVD rental transaction is performed at the article dispensing machine 230, transaction data such as the rented DVD title is then transmitted from the machine 230 to the central controller 302 via the network 301. It will be understood that central servers in general, such as the central controller 302, are often distributed. A plurality of central servers/controllers 302 may optionally be arranged in “load balanced” architecture to improve the speed and efficiency of the network. To accomplish the implementation of multiple controllers 302, the controllers 302 may be in communication with a router/distributor 303.

The central controller 302 is also in communication with a central database 304. The central database 304 stores information regarding the transaction network. For example, the central database 304 stores data regarding the vending inventory at each of the plurality of article dispensing machines 230. The central database 304 also stores sales information regarding the sales quantities of the vending merchandise stored in the machines 230. For example, the central database 304 stores information regarding the sales totals for each DVD title and for each machine 230 vending location. Central database 304 also stores user information and rental transaction information, such as user IDs, the date on which DVDs are due to be returned, the date on which DVDs were rented from the machines 230 and a list of valid coupon codes and restrictions associated with those codes. In certain embodiments, central database 304 also may be configured to store user PINs. Some of this information is also preferably stored in article dispensing machine database 282.

Central database 304 is preferably a relational database, although other types of database architectures may be used without departing from the principles of the present invention. For example, database 304 may be a SQL database, an Access database or an Oracle database, and in any such embodiment have the functionality stored herein. Central database 304 is also preferably capable of being shared, as illustrated, between a plurality of central controllers 302 and its information is also preferably capable of being transmitted via network 301. It will be understood that a variety of methods exist for serving the information stored in central database 304. In one embodiment, .net and Microsoft Reporting Services are employed, however, other technologies such as ODBC, MySQL, CFML and the like may be used.

The central controller 302 and central database 304 are also preferably accessible by a personal computer 306. The personal computer 306 will be understood as comprising hardware and software consistent with marketable personal computers, such as a display monitor, a keyboard and mouse and a microprocessor. The personal computer also comprises Internet browser software such as Firefox or Internet Explorer. Using the browser software, a user at the personal computer 306 can access a web interface through the central controller 302. To that end, central controller 302 preferably comprises web server software such as IIS or Apache. It will be understood that a variety of web server software and web browser software exists to implement the principles of the present invention without departing therefrom. Through the web browser software, the personal computer 306 communicates with the central controller 302 and allows the user to login to a central command functionality of the central controller 302 and to view and modify data stored in the central database 304. The browser interface also allows the user to perform certain system functions, which will affect the inventory and behavior of the article dispensing machines 230.

In a preferred embodiment, a financial server 305 is also in communication with the network 301. It will be understood that a variety of financial services exist for processing financial information via the Internet and other networks 301. Those services allow for the processing of credit card and debit card information, so that users of the services do not have to interface directly with credit and debit card companies. In FIG. 1, the financial server 305 is illustrated as a single server, although the financial server 305 may comprise an entire sub-network of financial servers 305 responsible for processing financial information.

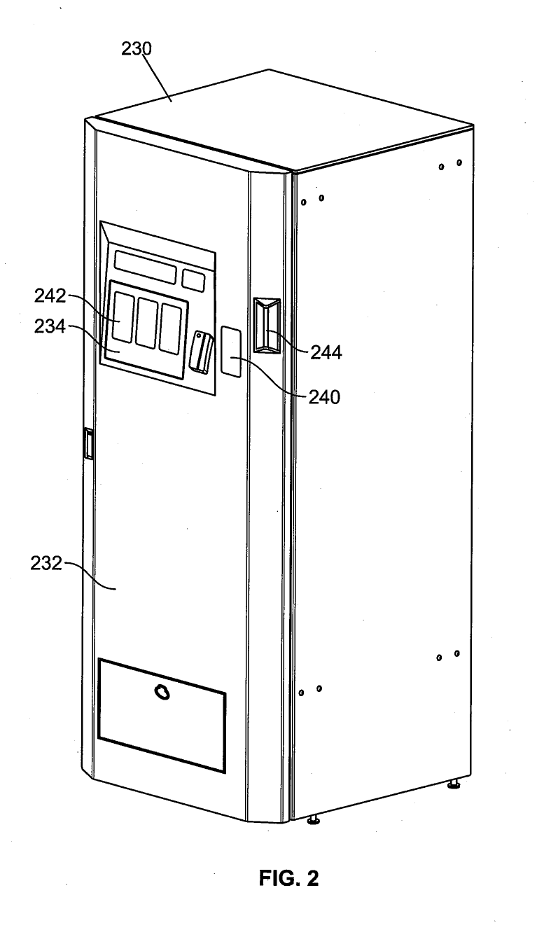

As shown in FIG. 2, article dispensing machine 230 includes a machine housing 232 with front, rear, top, bottom and side panels. The machine housing 232 is preferably a combination molded fiberglass and sheet metal cabinet. However, those skilled in the art will appreciate that the housing can be constructed from a variety of other suitable materials and with a variety of other suitable manufacturing techniques.

As shown most clearly in FIG. 2, a user interface portion 234 of housing 232 includes a card reader 240, a keypad and/or touch screen 242 and an article transfer opening 244. The card reader 240 is preferably designed in known fashion to read magnetically encoded membership and/or credit cards for authorizing the distribution of articles of inventory through the article transfer opening 244. Keypad and/or touch screen 242 permits consumers and/or inventory stocking personnel to communicate with the dispensing machine 230 and/or a central office linked in electrical communication with the dispensing machine. Keypad and/or touch screen 242 also permits consumers and/or inventory stocking personnel to enter appropriate commands directed to carrying out specific machine tasks. It will be appreciated that the optional touch screen includes a monitor made with known technologies making it capable of being utilized as a user interface for entry of commands designed to carry out machine tasks.

Furthermore, it will be appreciated that additional user interface portions having additional or even identical user interface components could be incorporated within article dispensing machine 230. For example, these components could be incorporated on other panels of the housing 232 of machine 230 so that the machine can be used simultaneously by multiple consumers, translating into more efficient distribution of articles in high traffic areas.

Dispensing machine 230 also preferably includes speaker units 246. Preferably, known audio technology is incorporated within dispensing machine 230 to broadcast focused audio directed to relatively small (e.g., three square feet) locations in front of the machines from speaker units 246 and/or in other designated locations at a hosting site.

### User Transactions

Turning now to the functioning of the machine during a consumer transaction, as a consumer approaches an article dispensing machine, the consumer observes the display monitor and the user interface 234. The consumer may also observe a plasma/LCD monitor displaying marketing information, or a lightbox containing marketing information for branding the vending apparatus 230. The consumer then enters the appropriate commands at the user interface control 234 associated with the dispensing machine to select a DVD to be dispensed by the machine. The user interface can employ simple menus and a fixed set of keys for consumers to make their selections, it can employ break-resistant touch screens, or it can employ a combination of both. Once a selection has been made, the consumer then merely inserts his/her magnetically encoded dispense activation card into the card reader 240 positioned at the front of the dispensing machine 230 and, in response, the machine will dispense the selected DVD without the need for further input by the consumer. Optionally, the user may also be prompted to enter a coupon code if the user has one.

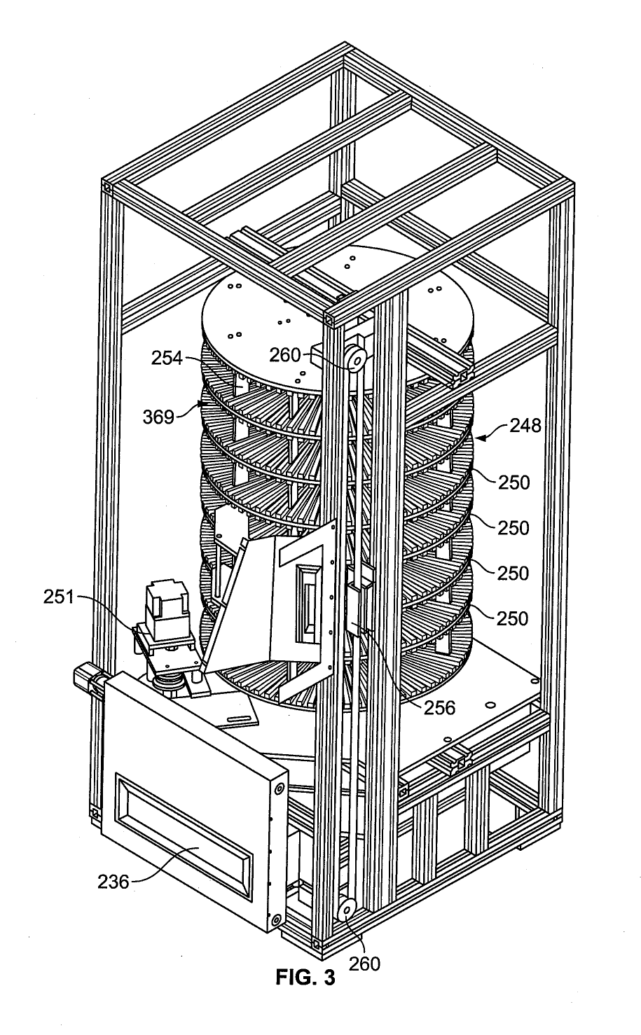

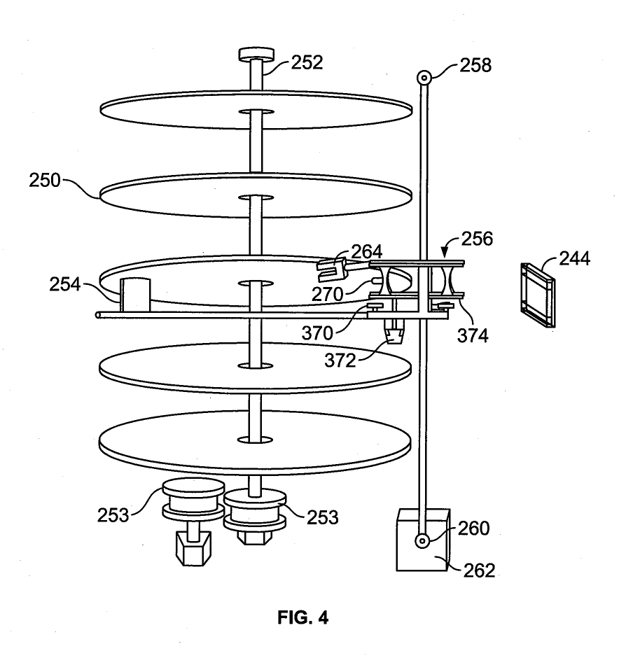

When the user has made a selection, a selector arm 256 shown in FIGS. 3 and 4, in connection with a picker 264, grabs and causes the selected DVD 254 housed in the dispensing machine 230 to be dispensed via the dispensing/receiving receptacle 244, preferably in less than twenty seconds. The specific user request made at the machine (e.g., renting a new movie or payment by credit card) is then sent via satellite feed or DSL or cable modem or via the Internet to a centralized system office in real-time for processing. Such a procedure ensures accurate and rapid handling of every user request as well as secure billing to any credit card account of the consumer. If the dispensing machine is offline, the transaction information may be stored locally at the article dispensing machine for later transmission to the central system.

When a consumer returns a DVD to a dispensing machine, the consumer inserts the DVD into the dispensing/receiving receptacle 244 on the front of the machine.

### Coupon Code Restrictions/Types of Coupon Codes

The present invention involves the use of coupon codes that may be inputted during a consumer transaction and a system that limits the use of such coupon codes to transactions meeting certain restrictions associated with the coupon code. One such restriction is a vendor restriction. Article dispensing machines may be located within retail stores including without limitation quick-service restaurants, grocery stores, convenience stores or pharmacies. Vendor-restricted coupon codes are restricted so that the coupon code may only be used at an article dispensing machines located in stores affiliated with a certain entity. For example, a vendor-restricted coupon code may be limited so that it can only be used in a certain chain of retail stores, for example, Walgreen's stores.

Another such coupon code restriction is a market restriction. Market restrictions are typically based on a geographic division of the network or plurality of dispensing machines. In one preferred embodiment, markets and market restrictions are divided by the Designated Marketing Areas™ as defined by Nielsen Media Research. Other geographic market restrictions may be based on a city, state, country, region or zip code designation.

Another type of coupon code restriction is a date range restriction. A date range restriction limits the coupon code so that it may only be redeemed during a specific range of dates and/or times. Date range restrictions are preferably used in connection with the coupon codes, but do not necessarily need to be used.

Yet another type of coupon code restriction is a first-time user restriction. The first-time user restriction only permits the code to be used in connection with a credit or debit card that has not been used to rent or purchase a DVD on a networked article dispensing machine. To check this restriction, the network must store a database of credit and debit card numbers that have previously been used for a consumer-transaction. A first-time user restriction, also called a “new-user” restriction, allows a promotion code to target new customers who have not used the article dispensing machines in the network before without permitting returning customers to use the coupon code.

Another category of restrictions is use-based restrictions. Use-based restrictions specify the number of times that a specific coupon code may be used. A use-once restriction only permits a coupon code to be used for one transaction. Thus, once one consumer has used the coupon code, it is no longer valid. Use-once restricted coupon codes are useful, for example, to provide a free rental to a customer who has reported a problem with a previous rental, such as a damaged DVD.

A use-once-per-card restriction only permits a coupon code to be used once in connection with a certain credit or debit card number. The use-once-per-card restriction permits all users to use the code, but only one time per user. An unlimited coupon code may be used an unlimited number of times.

Additionally, many of the restrictions may be combined. For example, a coupon code may be limited to a certain date range (date restriction), for use in a certain market (market restriction), and only allowed to be used once per card (use-once-per-card restriction).

### Use of Coupon Codes During a Consumer Transaction

During a consumer-transaction, the consumer may use a coupon code to receive a discount for the rental of a DVD. A coupon code is a multi-digit code, which is preferably made up of alpha-numeric characters, but could also be comprised of non-alpha-numeric symbols. The consumer may input the coupon code to the article dispensing machine 230 using the user-interface 234, which is preferably a keypad or touch screen keypad.

In a preferred embodiment, the dispensing machines may permit a consumer to enter a coupon code during a DVD rental transaction, however the dispensing machines may alternatively or additionally permit a customer to enter a coupon code during a DVD return transaction. Optionally, the dispensing machines may be limited to only accept a coupon code only during a rental transaction or only during a return transaction. Once the user has entered the coupon code via the user interface, the coupon code must be validated. Coupon code validation may either occur at the article dispensing machine or at the central controller.

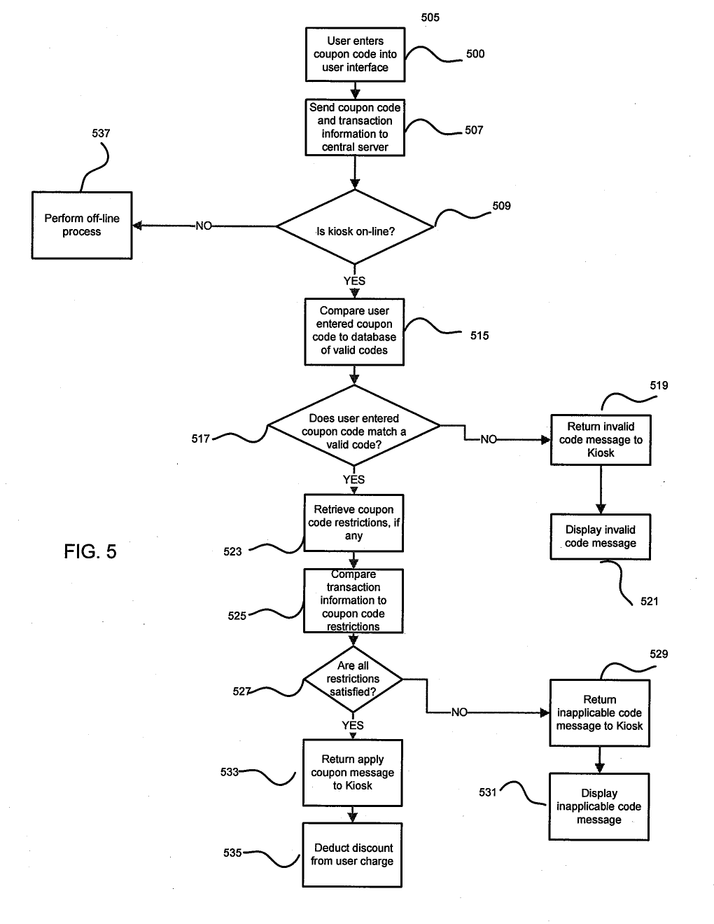

In a preferred embodiment of the coupon code redemption and verification process 500, shown in FIG. 5, the coupon code is validated at a central controller 302. Validation at the central controller minimizes the amount of data that needs to be stored at each dispensing machine and the amount of processing performed at each dispensing machine, thereby reducing the complexity of the design and the cost of the article dispensing machines.

As shown in FIG. 5, after the consumer enters the coupon code via the user interface 234 in step 505, a coupon redemption program, which is run on the article dispensing machine processor 300, is initiated. The dispensing machine processor then attempts to transmit the consumer-entered coupon code and transactional data to the central processor 302 via network 301, as shown in steps 507-509. The transactional data may include multiple different types of data, some of which may be encrypted. For example, the transactional data may include a unique address identifying the article dispensing machine. The transactional data may also include the credit or debit card number of the consumer. The transactional data may also include the date and time of the transaction and additional information about the dispensing machine location, such as the vendor and market in which it is located. The central server indicates to the article dispensing machine whether the transfer was successful, as shown in step 509. Alternatively, instead of attempting to transmit the information, the dispensing machine may use a “ping” to determine if the central processor is connected or able to be connected to the dispensing machine.

If the transfer of the user-entered coupon code and transactional information was successful, the central server then accesses the central database 304 stored on the central memory and which contains a master list of valid coupon codes. For each valid coupon code on the master list, the list may further have one or more restrictions associated with the coupon code. The restrictions may include, for example, a date range during which the coupon code is valid. The various restrictions are discussed in more detail above and below.

The central processor then compares the consumer-entered coupon code to the master list of valid coupon codes in step 515. If the consumer-entered coupon code does not match one of the valid coupon codes on the master list, the central processor 302 returns a message to the dispensing machine 230 that the consumer-entered coupon code is invalid, as shown in steps 517 and 519. The article dispensing machine then displays a message to the consumer via the screen 242 or other communication means, such as the speakers 246, indicating that the consumer-entered code was invalid 521. The article dispensing machine may also ask the consumer if he/she wishes to try another code.

If, on the other hand, the consumer-entered coupon code matches one of the valid coupon codes, the central processor 302 then retrieves the restrictions associated with the valid coupon code from the central memory 304, as shown in step 523. Next, the central processor 302 compares the transaction data received from the dispensing machine to the restrictions associated with the coupon code 525. If any of the coupon code restrictions are not satisfied by the transaction data, the central processor sends a message via the network to the dispensing machine indicating that the consumer-entered coupon code is inapplicable to the transaction, as shown in steps 527-531. Optionally, the central processor may also indicate the reason why the consumer-entered coupon code is inapplicable by indicating which restriction was not satisfied. For example, the central processor may indicate that the restriction that the coupon code is only valid at dispensing machines located in a certain zip code was not satisfied. The dispensing machine then conveys to the consumer via the user interface that the consumer-entered coupon code was inapplicable to the transaction. Optionally, the dispensing machine may also convey to the consumer the reason why the transaction was inapplicable. The dispensing machine may also present the consumer with the opportunity to enter another coupon code.

If, however, at step 527 after comparing the transaction data to the coupon code restrictions, the central processor determines that all coupon code restrictions are satisfied by the transaction data, the central processor sends a message via network 301 to the article dispensing machine 230 indicating that the coupon code is applicable to the transaction, as shown in step 533. The article dispensing machine processor then provides the discount input to the transaction charge calculation program as shown in step 535. Optionally, the article dispensing machine may also convey to the consumer that the consumer-entered coupon code was accepted and applied to the transaction.

Returning now to step 507, wherein the article dispensing machine first attempted to convey the coupon code and transaction data to the central processor or “ping” the central processor, if the attempt to transfer the information was unsuccessful, the article dispensing machine will treat the coupon code in an offline mode as shown in step 537.

### Offline Processing

When the dispensing machine is offline, the coupon code may be treated in one of a number of ways, each of which is addressed below. In the preferred embodiment, when the dispensing machine is offline, it simply rejects all coupon codes. Thus, once the article dispensing machine processor receives a signal that it is offline as shown in step 509, it conveys a message to the user that dispensing machine is unable to process the user-entered coupon code at that time.

In an alternate embodiment, once it is determined that the dispensing machine is offline in step 509, the article dispensing machine accepts all consumer-entered coupon codes. The article dispensing machine processor instructs the consumer transaction charging program to apply a standard discount, for example, one free day's rental, to the calculation of charges associated with the transaction. Optionally, the article dispensing machine may also convey to the consumer that the consumer-entered coupon code was accepted and applied to the transaction.

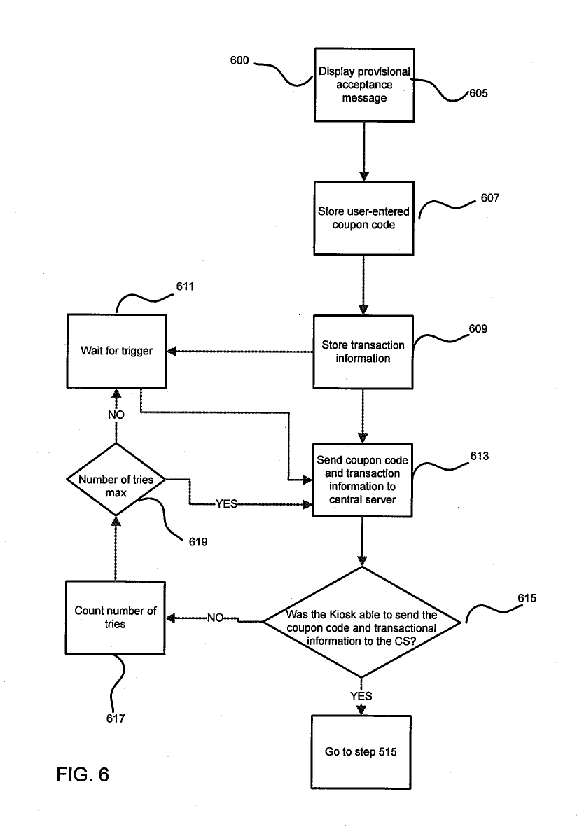

FIG. 6 shows another alternate embodiment for offline processing of coupon codes wherein the consumer-entered coupon code is provisionally accepted 600. In this embodiment, as shown in step 605, the article dispensing machine conveys a message to the consumer that the consumer-entered coupon code has been provisionally accepted pending verification of the code. The dispensing machine processor then saves the consumer-entered coupon code and transaction data in dispensing machine memory 281, as shown in steps 607 and 609. Charges to the consumer's credit or debit account are not processed until the validity of the consumer-entered coupon code has been determined.

At a later time, after the transaction data and consumer-entered coupon code have been stored, the dispensing machine processor attempts to convey the stored consumer-entered coupon code and transaction data to the central server via the network as shown in steps 611-619. This attempt to convey information may be triggered in a number of ways 611. For example, the program may be set to attempt to convey the stored information at a certain time every hour. Alternatively, the program may be set to attempt to convey the stored information a set time after it was saved. Alternatively or additionally, the dispensing machine may have a program that detects when the central server has established communication with the dispensing machine. After the program has attempted to send the stored information to the central server, the terminal may check to determine if the information was successfully sent to the central server 615. In one embodiment if the attempt to transmit the stored information was unsuccessful, the kiosk may count the number of attempts to send the information and, if the number of attempts was less than a maximum number of attempts, it may attempt to resend the information as shown in steps 617, 619 and 613. However, if the number of attempts has reached the maximum number of attempts the kiosk may wait for a trigger before attempting to send the information again 619. Upon detecting that communication has been established, the program may instruct the processor to attempt to convey the stored information to the central server 613.

Once the dispensing machine has successfully conveyed the stored information to the central server, the central server performs the coupon code validation as shown in steps 515-535 of method 500 in FIG. 5. If the consumer-entered coupon code does not match one of the valid codes stored on the central server database or if the transaction information does not satisfy all of the coupon code restrictions, then the central processor provides input to the consumer transaction charging program that the discount should not be applied because it is inapplicable to the transaction steps 517-521 and 529-531. If, on the other hand, the comparison performed by the central processor determines that the consumer-entered coupon code is a valid code and that all restrictions are satisfied, then the central processor provides input to the consumer transaction charging program that the coupon discount should be applied to the consumer charge, steps 517, 523, 527, 533 and 535.

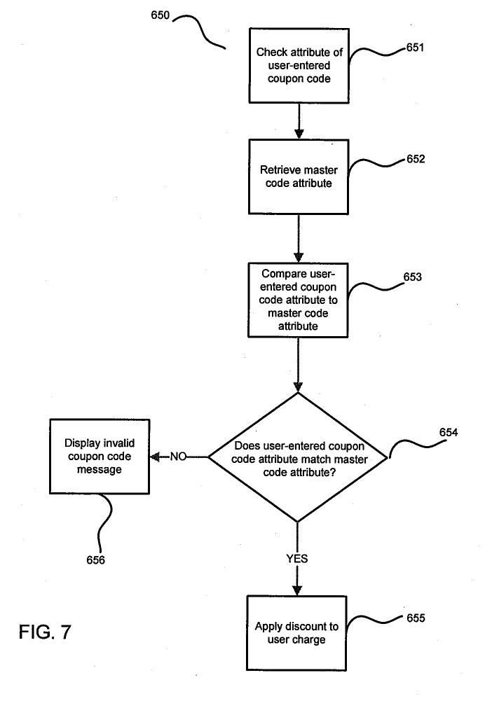

FIG. 7 shows yet another alternative embodiment 650 for offline processing of coupon codes wherein the article dispensing machine performs a coupon code attribute check to determine whether to accept the coupon code. In this embodiment, once it is determined that the dispensing machine is offline in step 509, the program checks an attribute of the consumer entered coupon code, step 651, and compares that attribute to a known value stored in the dispensing machine memory 281, steps 652-654. The attribute relates in some way to the letters, numbers or symbols that comprise the coupon code. For example, the program may perform a check sum operation in which the dispensing machine processor adds the value of each digit of the coupon code together to obtain a check sum value for the consumer-entered coupon code. The program then compares the check sum value of the consumer entered code against the stored master value. If the values match, the program provides input to the consumer charging program to apply the discount step 655. If the values do not match, the program instructs the processor to display a message to the user indicating that the consumer entered code is invalid and the program provides input to the consumer charging program not to apply a discount, step 656.

The checked attribute of the coupon code is not necessarily the sum of the digits that comprise the coupon code. Instead, it could be the sum of only some of the digits that comprise the coupon code. Alternatively, the checked attribute could be a certain character located in a certain position in the code; for example, the code must have a “7” as the 3^{rd} digit of the code. In another embodiment, the code could require a sum of certain digits and certain characters in certain positions. Thus, to avoid having the code cracked by consumers, the checked attribute could be designed with significant complexity so that it could not be readily deciphered. For example, in one complex embodiment, if a certain digit appears in a certain position in the coupon code, then the sum of the digits in the coupon code must equal one number, but if a different digit appears in that position, then the sum of the digits in the coupon code must equal another number.

Validation when the Code List is Stored at the Article Dispensing Machine

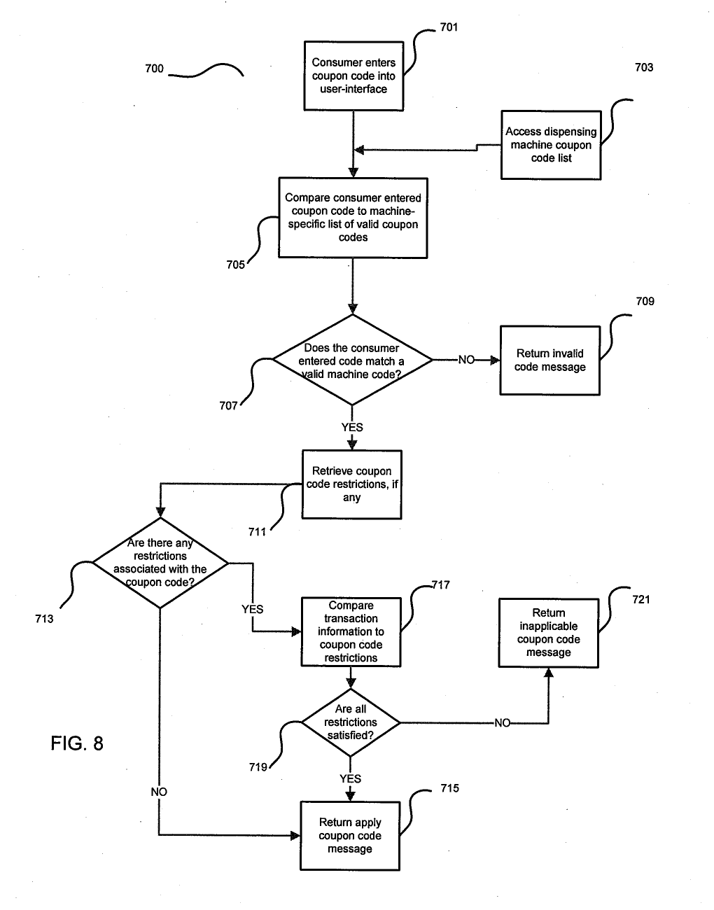

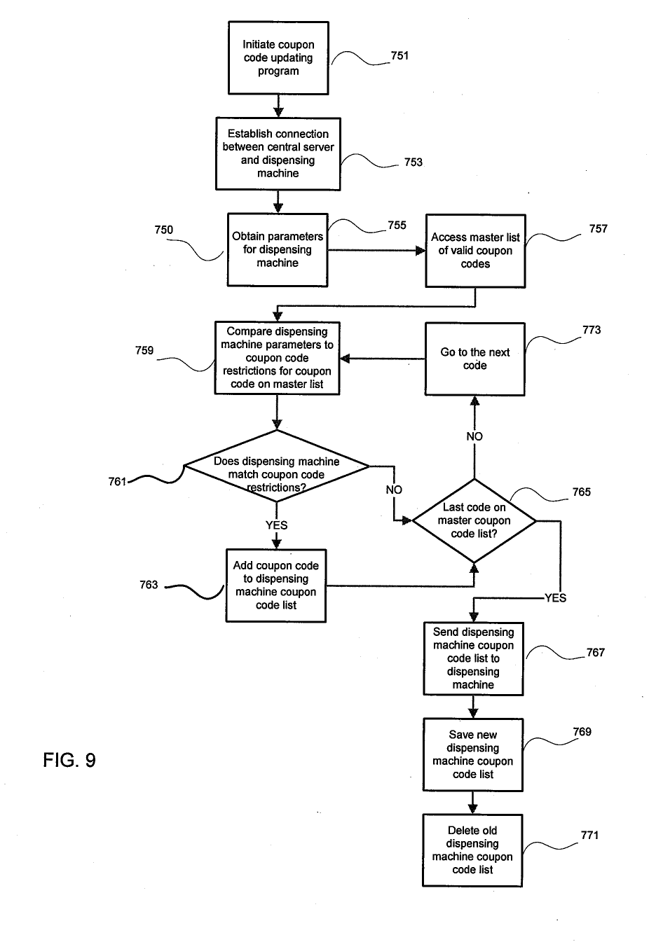

Yet another way of handling coupon codes when a dispensing machine is offline is to store a list of valid coupon codes and the corresponding restrictions at the article dispensing machines and to perform the validation at the article dispensing machine, as shown in flowcharts 700 and 750 in FIGS. 8 and 9. In this method, a master list of valid coupon codes and the restrictions associated with the coupon code are stored on the central database 304. In addition to the central database having the master coupon code list stored thereon, the article dispensing machines have a dispensing machine specific coupon code list stored on the dispensing machine database 282. The article dispensing machine specific coupon code list only contains those coupon codes that are valid for use at the specific article dispensing machine. For example, if the article dispensing machine is located in Chicago, the article dispensing machine will contain codes that have a market restriction which requires that they be used in Chicago or in Illinois, but will not contain codes that are only valid in New York. In this way, the article dispensing machine is able to validate coupon codes without connecting to the central server. In addition, storage at the article dispensing machine is minimized because each machine only needs to store the codes that are valid at that machine. To maintain an updated list of codes at the article dispensing machine, periodically, the central processor connects to the article dispensing machine to update the list stored on the article dispensing machine.

One exemplary method of updating the article dispensing machine specific coupon code list is shown in FIG. 9. First, the coupon code updating list program is initiated, step 751. The coupon code updating list program may be initiated by a certain event, for example, it may be triggered at a certain time each day or each week. Alternatively, the program may be initiated if a certain amount of time has passed since the last update.

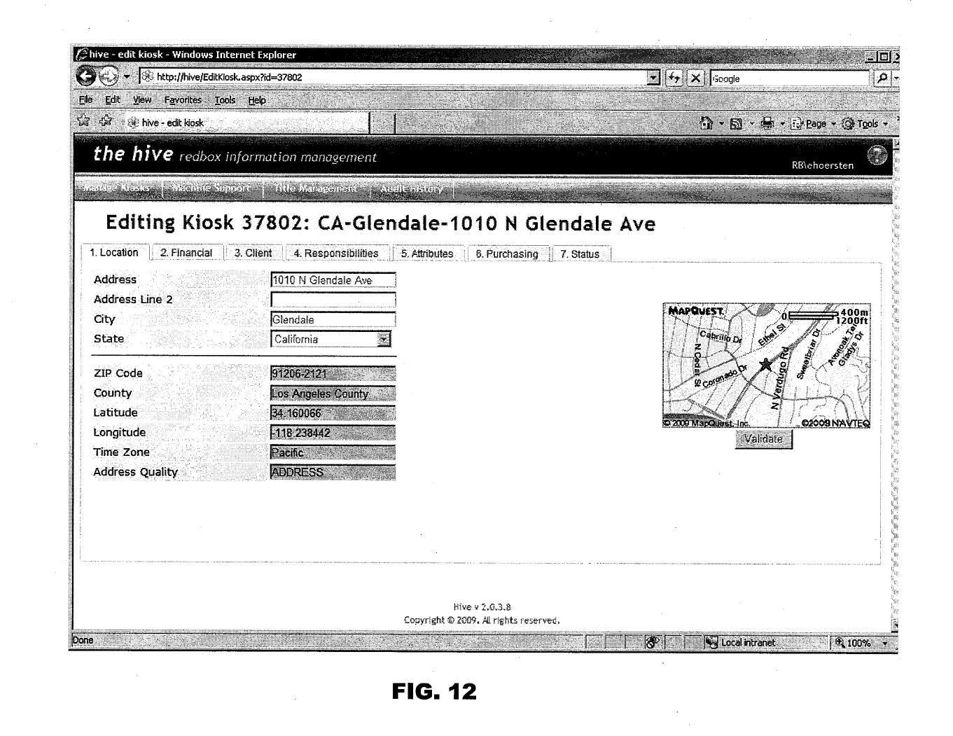

In method 750 shown in FIG. 9, the central server establishes a connection with one of the article dispensing machines via network 301, as shown in step 753. This step may occur at any point in the transaction. Optionally, as shown in step 755, once a connection has been established, the central processor may obtain the parameters of the article dispensing machine from the memory of the article dispensing machine. An exemplary dispensing machine parameter user-interface screen 870 is shown in FIG. 12. The parameters may comprise, for example, the vendor in which the machine is located, the physical address at which the machine is located and the market in which the machine is located among others. Alternatively, the central server may have a database stored on the central server memory that identifies the parameters associated with each dispensing machine. If such a database of article dispensing machine parameters exists, the central processor may only require a unique identifier for each machine and it may then use this unique identifier to look up the parameters of the article dispensing machine on the database.

Once the central processor has obtained the parameters associated with the dispensing machine, it accesses a database stored in the central memory, which contains the master list of coupon codes and the restrictions associated with each coupon code step 757. The central processor then compares the parameters of the dispensing machine to the restrictions associated with each coupon code, as shown in steps 759-761. Steps 765 and 773 show a loop process for checking each coupon code one at a time, however, other methods known in the art to perform such a comparison are encompassed within the scope of the invention. As shown in step 763, the dispensing machine parameters meet the restrictions associated with a coupon code, the coupon code, and optionally its associated restrictions are added to a dispensing machine specific coupon code list, which may be temporarily stored on the central memory 304. Coupon codes having restrictions that are not satisfied by the parameters of the dispensing machine are not added to the dispensing machine coupon code list, step 761. Optionally, the vending machine may instead sequence through each coupon code on the master coupon code list, comparing the restrictions of each coupon code listed on the master list with the article dispensing machine parameters stored in a dispensing machine parameter data base. If the parameters of the dispensing machine match the restrictions, the coupon code is added to the article dispensing machine coupon code list.

Once all coupon codes on the master coupon code list have been checked against the parameters of the article dispensing machine, step 765 the central processor sends the dispensing machine coupon code list to the article dispensing machine via the network, step 767. As shown in steps 769 and 771, the article dispensing machine then saves the dispensing machine coupon code list on the dispensing machine memory 281 and deletes the old dispensing machine coupon code list from the dispensing machine memory.

The coupon code list updating program may be configured to update a single dispensing machine or it may be configured to update all of the dispensing machines when it is run. The method 750 in FIG. 9 shows a method for updating one dispensing machine. Method 750 may be repeated for each dispensing machine in order to update all of the dispensing machines in the network. Alternatively, a group of dispensing machines having common parameters may be updated at the same time using this method if the same coupons will be valid for all such machines. For example, all dispensing machines located in Walgreen's vendors, in Chicago may receive the same list of valid coupons because they have the same vendor type and same location parameter.

When the coupon codes are stored at the dispensing machines, the coupon code validation process may be performed at the article dispensing machine, as shown in method 700 in FIG. 8. After the user enters the coupon code via the user interface in the initial step 701, the coupon code validation program accesses the dispensing machine specific coupon code list stored on the dispensing machine memory as shown in step 703. The dispensing machine processor then compares the consumer-entered coupon code with the dispensing machine coupon code list as shown in step 705. If the consumer-entered coupon code does not match any of the codes on the dispensing machine coupon code list, the program instructs the dispensing machine to convey a message to the consumer that the coupon code is invalid for that transaction, as shown in steps 707 and 709. If the consumer-entered coupon code does match one of the codes on the dispensing machine coupon code list, the program next, optionally, checks the article dispensing machine coupon code list to determine if there are any additional restrictions associated with the coupon code, step 711. For example, the coupon code may have a date restriction or use restriction as described above. If there is no additional restriction associated with the coupon code, the program instructs the consumer transaction charging program to apply the discount to the consumer charge for the transaction 713 and 715. The program may also instruct the dispensing machine to convey a message to the consumer that the coupon code has been accepted. If, on the other hand, there are additional restrictions associated with the coupon code, the program retrieves the restrictions from the dispensing machine coupon code list and compares the transaction data with the coupon code additional restrictions 717. If all of the additional restrictions are not satisfied by the transaction data, the program instructs the dispensing machine to convey a message to the consumer that the consumer-entered coupon code is invalid for that transaction, as shown in steps 719 and 721. If all of the additional restrictions are satisfied, as shown in steps 719 and 715, the program instructs the consumer transaction charging program to apply the discount to the consumer charge for the transaction and may convey a message to the consumer that the coupon code has been accepted.

In an alternative method for validating a coupon code at an article dispensing machine, as shown in method 700, described above, of FIG. 8. Instead of having the dispensing machines store only the coupon codes that are valid at that dispensing machine, each dispensing machine may store the entire list of valid coupon codes and the validation of the consumer entered coupon code is performed at the article dispensing machine. In this method, all of the valid coupon codes stored on the central database are sent to each article dispensing machine via the network. The coupon code validation process then occurs at the article dispensing machine as set forth above and exemplified by method 700 of FIG. 8.

### Restriction Verifications

The comparison of the various coupon code restrictions to the transaction data, which is performed by the processor, differs depending on the type of restriction. For example, to verify a vendor restriction, the processor compares the vendor identifier or identifiers associated with the coupon code to the vendor identification associated with the article dispensing machine at which the coupon code was entered.

Verification of a market restriction may occur in a number of ways. Each article dispensing machine has an article dispensing machine identifier, such as an alpha-numeric code. Alternatively, the article dispensing machine identifier could simply be the address of the article dispensing machine or another such identifier. The central memory and/or the article dispensing machine memory may have a stored set of information, such as a database, that correlates the article dispensing machine identifier to a specific Audience Distribution Market, city, state, region, zip code and/or vendor. The article dispensing machine identifier may also be associated with other attributes of the article dispensing machine, for example, whether the dispensing machine is located indoors or outside.

During verification, the processor may use the article dispensing machine identifier to look up the Audience Distribution Market, city, state, region and zip code for the article dispensing machine and compare this information to the market restriction associated with the coupon code. Alternatively, each article dispensing machine may have stored in the dispensing machine memory the Audience Distribution Market, city, state, region and zip code associated with that dispensing machine. This information, instead of the identifier, may be transmitted to the central server as transaction information when using centralized coupon code verification.

A date restriction is verified by accessing a clock program running on either the central processor or the dispensing machine processor and comparing the time or date taken from the clock program to the date range specified by the restriction.

To verify a first-time-user restriction, the system stores and maintains in the central memory a database of credit and debit card numbers that have been used during consumer transactions. The stored credit and debit card numbers may be stored as a one-way hash of the credit and debit card numbers, or other suitable encryption methods may be used. The term “identity of a credit or debit card number” is used herein to refer to either the credit or debit card numbers or a hash or other representation of those numbers. During the verification process, the consumer credit or debit card number, or a hash or encryption thereof, is compared to the list of previously used credit and debit card numbers (or a hash or encryption thereof) stored at the central memory. If the identity of the consumer credit or debit card number does not match one of the identities of the numbers on the previously used card number list, then the restriction is satisfied. The date and time may be transferred from the dispensing machine to the central processor, or it may be obtained by the central processor.

To verify a use-once-per-card restriction, the system stores and maintains, in the central memory, a database of card numbers with which the coupon code has been redeemed. The list of card numbers is preferably encrypted. During the verification process, the consumer credit card or debit card number associated with the transaction is compared to the list of credit and debit card numbers that were previously used with the consumer-entered coupon code. If the consumer credit or debit card number does not match one of the numbers on the previously used card number list for the code, then the restriction is satisfied.

A use-once restriction does not require a separate verification once the user-entered coupon code has been checked against a master list; but, after the code has been used, the master code list stored on the central memory must be updated to reflect that the coupon code is no longer valid. The list may be updated by deleting the coupon code from the valid coupon code list, or, alternatively, by marking the code as no longer a valid code.

Unlimited use codes do not have any additional use restrictions. Unlimited codes are often used by service people to test a dispensing machine without having to pay for a transaction.

### Configurations of Codes

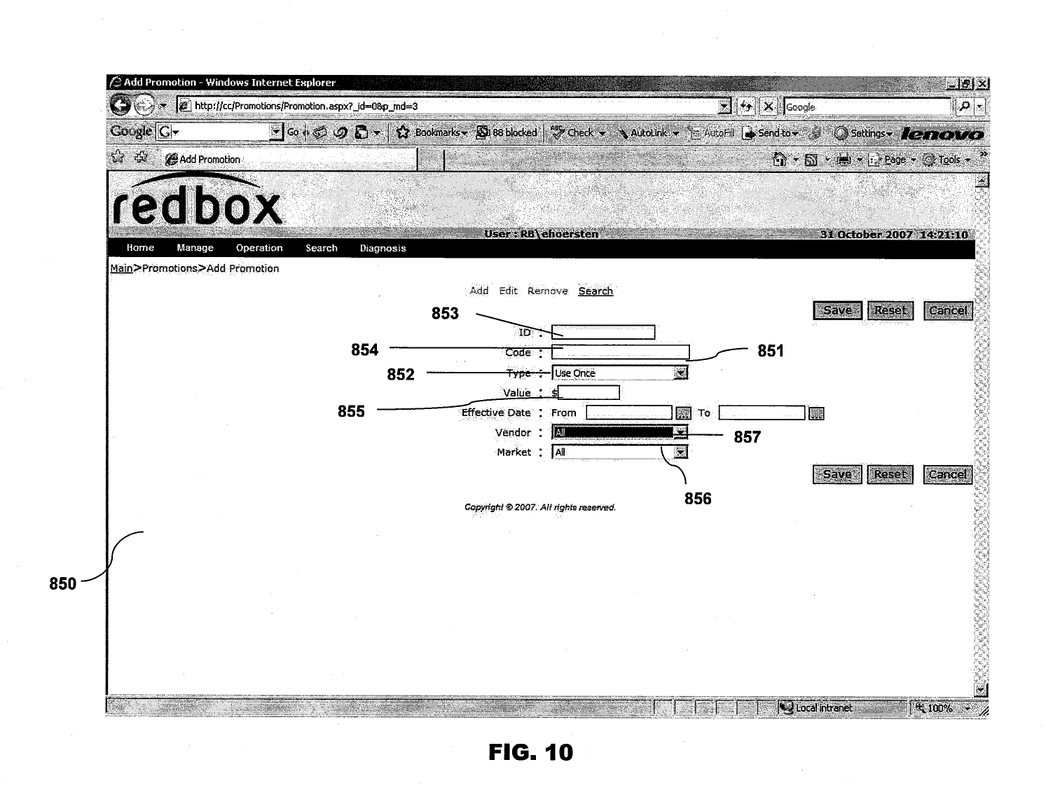

The present invention also comprises a method and a coupon code configuration user-interface for setting up new codes, editing codes, or deleting codes. As shown in FIG. 1, the coupon code configuration user interface is housed in a computer terminal 306 connected to the central database 304 and through which an administrator or manager can manage multiple coupon codes over a national network of article dispensing machines. As shown in FIG. 10, an exemplary coupon code configuration user interface screen 850 provides multiple fields 851, which are used to manage, add, edit or modify the restrictions and other attributes for new or existing coupon codes. Coupon code configuration user interface screen 850 provides a first field for searching existing coupon codes. Coupon codes may be searched by type, identification number, code number, value, effective date, market or vendor. The coupon type field 852 relates to the use type restrictions associated with the coupon code, namely the first-time-user, use-once-per-card, use-once and unlimited types of coupons. The identification number 853 is an alpha-numeric identification which may differ from the coupon code itself. Thus, the identification number can be used to refer to the coupon code without using the code, a feature which is useful for referencing an unlimited code while maintaining the secrecy of the code. The code number 854 is the coupon code itself. The value field 855 identifies the value of the discount associated with the coupon code. The market field 856 identifies the market in which the coupon code is valid; and, the vendor field 857 identifies the vendor chain or vendor type for which the coupon code is valid. In the coupon code add and edit options, all of these parameters may be selected or adjusted as desired.

Once a coupon code has been added, deleted or modified, the coupon code master list is updated to reflect the changes. In one preferred embodiment, the coupon code master list may be updated immediately after the coupon code has been added, deleted or modified. In this embodiment, once the user selects the save button on the coupon configuration user interface screen, the coupon code configuration program sends the requested change to the coupon code master list, thereby modifying the master coupon code list. Alternatively, the user inputted changes to the coupon codes may only be uploaded to the coupon code master list periodically. In this configuration, once the user selects the save button on the coupon configuration user interface screen, the coupon code configuration program saves a temporary file containing the changes requested by the user. The temporary files containing the changes to the coupon codes may all be sent to the master coupon code list on a periodic basis.

The present invention also comprises a method and interface for tracking and reviewing the usage of coupon codes. Each time a coupon code is used in connection with a transaction, certain transaction parameters may be recorded at the central memory. For example, the system preferably records the date of the transaction, whether the transaction involved the use of a new credit or debit card, i.e. whether it was a first time user transaction, the market in which the code was used and the vendor type associated with the dispensing machine at which the coupon code was used. The transactions and the associated transaction parameters may be stored in a searchable database saved on the central memory 304.

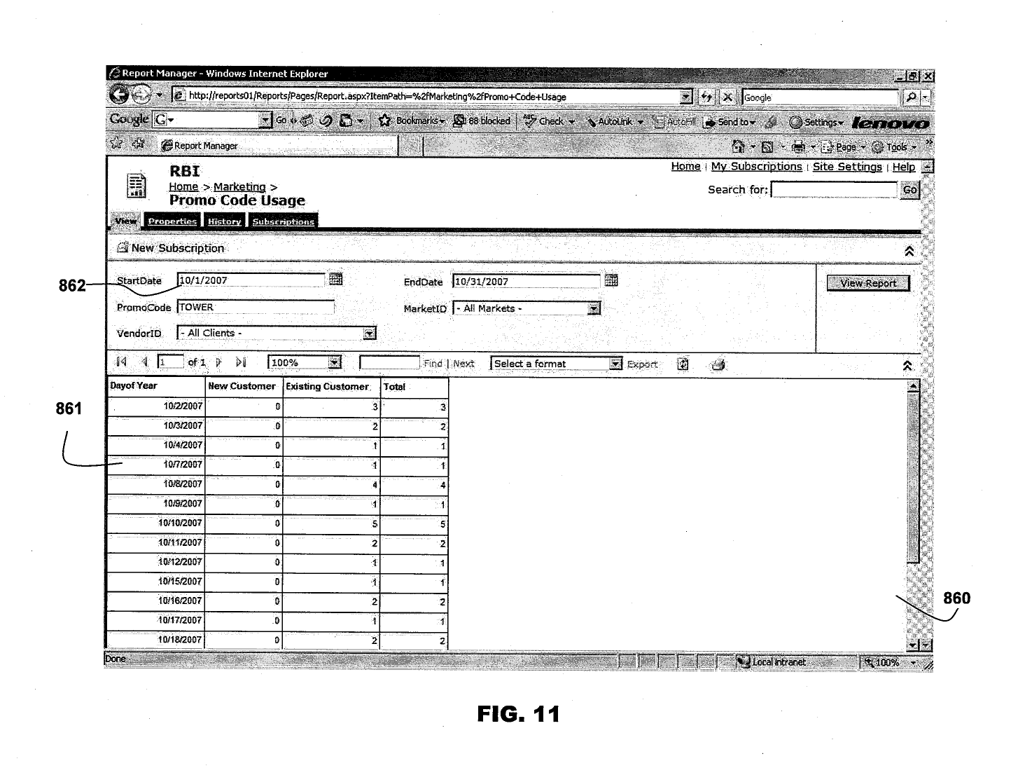

FIG. 11 shows an exemplary coupon code usage user interface screen 860 that enables a user to run a customized coupon code usage report 861. The coupon code usage user interface screen provides various fields 862 to allow the user to customize the report. For example, the customer may specify the date range, the coupon code, the market or markets and the vendor or vendors in which the dispensing machines were housed. Such reports are useful to determine the effectiveness of coupon code promotions and the relative effectiveness of a promotion in one market or vendor compared to another. Such reports are also useful to detect a spike in coupon code usage. For example, for an unlimited coupon code, a spike in coupon code usage often indicates that the code is being used by an unauthorized user.

Once a user has entered the desired report parameters, the coupon code usage report program searches the transaction database for transactions meeting the report parameters. Once the transaction database has been searched, a report 861 identifying the transactions that meet the parameters is displayed to the user.

Any process descriptions or blocks in figures represented in the figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

While the specific embodiments have been illustrated and described, numerous modifications come to mind without significantly departing from the spirit of the invention, and the scope of protection is only limited by the scope of the accompanying Claims.

What is claimed is:

1. A method for providing a discount for a consumer transaction at an article dispensing machine located in a store that has an affiliation with an entity, the article dispensing machine having a user interface connected to a processor and configured to communicate with a central processor, the method comprising the steps of:
receiving a consumer-entered coupon code via the user interface;
in response to the receipt of the consumer-entered coupon code, automatically comparing the consumer-entered coupon code to a first list of valid coupon codes;
comparing transaction data associated with the consumer transaction to a first restriction associated with the consumer-entered coupon code, wherein the first restriction is based on the affiliation of the store in which the article dispensing machine is located; and
providing the discount to the consumer transaction if the consumer-entered coupon code matches one of the valid coupon codes on the first list of valid coupon codes and if the transaction data satisfies the first restriction.

2. The method of claim 1 wherein the article dispensing machine is a media rental machine and the discount is a value that corresponds to a free time period of rental.

3. The method of claim 1 further comprising the step of:
comparing the transaction data to a second restriction associated with the consumer-entered code.

4. The method of claim 2 wherein the second restriction is a geographic restriction.

5. The method of claim 1 further comprising the steps of:
transmitting the transaction data from the article dispensing machine to a central processor via a network; and
wherein the first list of valid coupon codes is stored in a central memory connected to the central processor, the central processor performing the step of comparing the consumer entered coupon code to the first list of valid coupon codes.

6. The method of claim 1 wherein the first list of valid coupon codes is stored in memory in the article dispensing machine; wherein a second list of valid coupon codes is stored in a central memory connected to the central processor and the first list of valid coupon codes is a subset of the codes that comprise the second list of valid coupon codes; and wherein a dispensing machine processor located in the article dispensing machine performs the step of comparing the consumer entered coupon code to the first list of valid coupon codes.

7. The method of claim 6 further comprising the step of:
generating the subset of codes that comprise the second list of valid coupon codes at the central processor and transferring the subset of codes that comprise the second list of valid coupon codes to the article dispensing machine.

8. The method claim of claim 7 wherein the step of generating the subset of codes that comprise the second list of valid coupon codes is based on a comparison of a parameter associated with the article dispensing machine to the first restriction associated with the coupon code.

9. A method for checking the validity of a user-entered code for a discount for a transaction conducted at an article dispensing machine, the article dispensing machine having a user input and being connected to a central processor via a network, the central processor being connected to a central memory having a master list of valid codes and restrictions associated with those codes stored thereon, the method comprising the steps of:
receiving the user-entered code via the user input;
determining if the article dispensing machine is able to establish data communication with the central processor;
if the article dispensing machine is able to establish data communication with the central processor, transmitting the user-entered code and transaction data to the central processor via the network, and the central processor comparing the user-entered code to the master list of valid codes and comparing the transaction data against the restrictions associated with the user-entered code; and
if the article dispensing machine is not able to communicate with the central processor, performing an offline code validation process.

10. The method of claim 9 wherein the offline code validation process comprises the step of:
accepting any user-entered code.

11. The method of claim 9 wherein the offline code validation process comprises the steps of:
checking an attribute of the user-entered code against a predetermined attribute; and
accepting the user-entered code if the attribute of the user-entered code matches the predetermined attribute.

12. The method of claim 11 wherein the predetermined attribute is the sum of a least some of the digits of the user-entered code.

13. The method of claim 9 wherein the offline code validation process comprises the steps of:
storing the user-entered code at the article dispensing machine;
establishing communication between the article vending machine and the central processor;
transmitting the user-entered code to the central processor via the network; and
the central processor comparing the user-entered code to the master list of valid codes and comparing the transaction data against the restrictions associated with the code.

14. The method of claim 9 wherein the offline code validation process comprises the steps of:
rejecting all codes received through the user interface; and
communicating to a user a message informing the user that the user-entered code cannot be redeemed.

15. The method of claim 10 further comprising the step of:
transmitting a signal from the central processor to the article dispensing machine indicating that the code is either valid or invalid.

16. The method of claim 15 further comprising the step of:
if the code is invalid, communicating to the consumer the reason that the code is invalid.

17. The method of claim 9 wherein one of the restrictions is a new-user restriction and the transaction data comprises an identity of a debit or credit card number.

18. A network of article dispensing machines comprising:
an article dispensing machine comprising:
a user interface configured to receive a user-entered coupon code;
a dispensing machine processor in communication with the user interface; and
a dispensing machine memory in communication with the dispensing machine processor and containing at least one parameter associated with the article dispensing machine; and
a central memory remote from the article dispensing machine and containing a master list of valid codes comprising a plurality of valid codes, at least one of the valid codes having a first restriction associated therewith and stored in the central memory; and
a central processor in communication with the article dispensing machine and the central memory, for comparing the user-entered code with the master list of valid codes and for comparing the at least one parameter associated with the first dispensing machine to the first restriction.

19. The network of article dispensing machines of claim 18 wherein the at least one parameter is an identifier of the geographic location of the article dispensing machine.

20. The network of article dispensing machines of claim 18 wherein the at least one parameter is an identification of the affiliation of the store in which the article dispensing machine is located.

21. The network of article dispensing machines of claim 18 wherein the article dispensing machine further comprises:
means for determining whether the first dispensing machine is in communication with the central processor and a means for performing an offline code validation process.

22. A network of article dispensing machines comprising:
an article dispensing machine associated with an article dispensing machine identifier, the article dispensing machine comprising:
a user interface configured to receive a user-entered coupon code;
a dispensing machine processor in communication with the user interface; and
a dispensing machine memory in communication with the dispensing machine processor; and
a central memory remote from the article dispensing machine and containing a master list of valid codes comprising a plurality of valid codes, at least one of the valid codes having a first restriction associated therewith and stored in the central memory, the central memory further containing the article dispensing machine identifier and at least one parameter linked to the article dispensing machine identifier; and
a central processor in communication with the article dispensing machine and the central memory, for comparing the user-entered code with the master list of valid codes and for comparing the at least one parameter linked to the article dispensing machine identifier to the first restriction.

23. The network of article dispensing machines of claim 22 wherein the at least one parameter is an identifier of the geographic location of the article dispensing machine.

24. The network of article dispensing machines of claim 22 wherein the at least one parameter is an identification of the affiliation of the store in which the article dispensing machine is located.

25. The network of article dispensing machines of claim 22 wherein the article dispensing machine further comprises:
means for determining whether the first dispensing machine is in communication with the central processor and a means for performing an offline code validation process.

26. A network of article dispensing machines comprising:
an article dispensing machine comprising:
a user interface configured to receive a user-entered coupon code and an identity of an account number from a credit or debit card; and
a dispensing machine processor in communication with the user interface;
a central memory remote from the first article dispensing machine and containing a master list of valid codes comprising a plurality of valid codes wherein at least one of the valid codes has a first restriction limiting the code to new-user transactions, the central memory having the first restriction and a database of identities of account numbers of credit or debit cards previously used for transactions within the network stored thereon; and
a central processor in communication with the first article dispensing machine and the central memory, wherein the central processor compares the user-entered code with the master list of valid codes and compares the received identity of the account number to the database of identities of account numbers previously used for transactions within the network.

27. The network of article dispensing machines of claim 22 wherein the at least one valid code has a second restriction limiting the code to transactions at dispensing machines affiliated with a certain entity.

28. A computer system for validating a coupon code, the computer system comprising:
means for receiving data from an article dispensing machine affiliated with an entity and in communication with the computer system, the data comprising a coupon code and transaction data, wherein at least a portion of the transaction data comprises an identity of the entity;
a database having a master list of valid codes comprising a plurality of valid coupon codes, at least one of the valid coupon codes having a first restriction associated therewith, the first restriction comprises an identity of an entity;
a computer readable program code device configured to cause the computer system to compare the received coupon code to the master list of valid coupon codes and to compare the transaction data to the first restriction, thereby determining the validity of the code; and
means for sending a signal indicating whether the received code is valid in response to the data received from an article vending machine.

29. The computer system of claim 28, wherein a portion of the transaction data comprises an identity of a transaction card number and wherein the at least one of the valid coupon codes has a second restriction associated therewith, the second restriction being a first-time user restriction, the computer system further comprising:
a database containing identities of transaction card numbers that have been used for transactions at article dispensing machines in communication with the computer system; and
wherein the computer readable code device is configured to cause the computer system to compare the identity of the received transaction card number to the database of identities of transaction card numbers that have been used for transactions at article dispensing machines in communication with the computer system, thereby determining whether the first-time user restriction is satisfied.
